(19) United States
(12) Patent Application Publication
(10) Pub. No.: US 2004/0200306 A1
(43) Pub. Date: Oct. 14, 2004

(54) Safety device for locking an adjustable connecting piece

(75) Inventor: Burkhard Schafer, Ganderkesee (DE)

Correspondence Address: John James McGlew, McGLEW AND TUTTLE, Scarborough Station, Scarborough, NY, 10510-0827, US

(73) Assignee: NACAM DEUTSCHLAND GmbH

(21) Appl. No.: 10/834,309

(22) Filed: Apr. 28, 2004

Related U.S. Application Data
(63) Continuation of application No. PCT/DE03/01976, filed on Jun. 12, 2003.

(30) Foreign Application Priority Data
Jun. 14, 2002 (DE) DE 102 26 769.3

(51) Int. Cl. B62D 1/16

(52) U.S. Cl. 74/493

(57) ABSTRACT

At least one first mounting part (1), which has at least one passage opening (1a) for guiding a connector (3). The connector connects to one another at least two clamping parts (4, 7) that are movable in relation to one another, which clamp the connecting piece (2). The connector (3) and the clamping parts (4, 7) form a first clamping mechanism. Structure is provided for securing the first clamping mechanism, and includes a second clamping mechanism (10, 11), which is located between the clamping parts (4, 7) of the first clamping mechanism and is coupled with same. The second clamping mechanism has at least one second mounting part (1), which has a passage opening (11a) that is at least congruent with the passage opening (1a) of the first mounting part (1), as well as a spindle (10), which is connected with the first clamping mechanism (3, 4, 7) via a clamping part (4) of the first clamping mechanism (3, 4, 7). The clamping part (4) is designed as a spindle nut, so that the two clamping mechanisms (3, 4, 7; 10, 11) can be released or locked via the first clamping mechanism (3, 4, 7).

### CROSS REFERENCE TO RELATED APPLICATION

This is a continuation of and claims the benefit (35 U.S.C. §120 and 365(c)) of copending International Application PCT/DE03/01976 of 12 Jun. 2003, which designated inter alia the United States and this International Application claims the priority of German Application DE 102 26 769 of 14 Jun. 2002. The entire contents of each application is hereby incorporated by reference in its entirety.

### FIELD OF THE INVENTION

The present invention pertains to a safety device for locking an adjustable connecting piece, especially a jacket tube of a steering column of a motor vehicle, with at least one mounting part, which has at least one passage opening for guiding a connector that connects at least two clamping parts that are movable in relation to one another and clamp the connecting piece, wherein the connector and the clamping parts form a first clamping mechanism, and means are provided for securing the clamping mechanism.

### BACKGROUND OF THE INVENTION

Such safety devices are used, among other things, in motor vehicles in conjunction with the adjusting means of an adjustable steering column to avoid safety hazards.

Operating elements, for example, the steering wheel, and other means of a motor vehicle (seat, mirrors) are adjustable corresponding to the passenger's individual needs because of ergonomic and safety engineering conditions. Corresponding locking or clamping devices are needed in order to prevent the setting of these operating elements, such as steering wheel or seat, from changing spontaneously during the operation and thus from representing a safety hazard. Moreover, some safety elements are based on adjustable operating elements, for example, a driver's side air bag in a steering wheel, which is connected to an adjustable steering column. To guarantee the corresponding safety function of an air bag, it must be ensured that these safety elements withstand the loads that occur. Thus, a safety element, for example, an air bag, is designed such that the construction supporting it will not yield, for example, in a direct collision.

A clamping device that has a blocking element as an additional clamping mechanism is known from the patent DE 195 06 210 C1. When safety function is needed, this blocking element presses the inner surface of the connecting piece, e.g., of a jacket tube, with a sword-like edge and thus ensures a nonpositive clamping function. The sword-like edge can dig into the surface of the connecting piece under higher loads and thus additionally generate an increased clamping action.

The drawback that occurs with the prior-art clamping devices or safety devices is that in case of a frictionally clamped safety device, the high, pulse-like loads occurring during a direct collision are not absorbed reliably by the clamping device, and the position of the steering column will therefore change (so-called negative crash behavior). Even though the above-mentioned loads are absorbed in the case of a positive-locking safety device, so that the position of the steering column will not change, a continuous, individual setting is no longer possible in this case because of the division of the safety device. Moreover, a “head-to-head” position cannot be completely prevented from occurring in the case of clamping separated via teeth, which likewise leads to slipping through under a pulse-like load.

### SUMMARY OF THE INVENTION

One of the objects of the present invention is therefore to provide a device in which the continuous, individual setting of a connecting piece is guaranteed and which reliably absorbs the loads occurring in a direct collision, without a change in the position of the connecting piece, so that satisfactory function of the safety devices based on this safety function, for example, of an air bag, is ensured.

This object is accomplished on the basis of a device with a first connecting piece and a second connecting piece arranged inside the first connecting piece. The second connecting piece is movably mounted in the first connecting piece in an adjusting direction. A connector is arranged around the first connecting piece. The connector has a first clamp selectively clamping the connector to the first connecting piece and fixing the first connecting piece to the second connecting piece. The connector has a second clamp selectively locking the connector to the first connecting piece and fixing the first connecting piece to the second connecting piece. The second clamp includes a spindle nut connected to the first clamp to be locked and unlocked by clamping and unclamping of the first clamp.

The present invention includes the technical teaching that the means for locking the clamping mechanism comprise a second clamping mechanism, which is located between the clamping parts of the first clamping mechanism, is coupled with the first clamping mechanism, and has at least one second mounting part, which has a passage opening that is at least congruent with the passage opening of the first mounting part, as well as a spindle, which is connected with the first clamping mechanism via a clamping part of the first clamping mechanism, which said clamping part is designed as a spindle nut, so that both clamping mechanisms can be detached or locked via the first clamping mechanism.

The solution according to the present invention offers the advantage that because of the combination of the two different principles of clamping—the nonpositive clamping and the positive-locking clamping—the advantages of the two principles are combined and a better safety function and greater comfort for the user are thus achieved.

The first mounting part is preferably designed as a bracket provided with a U-shaped part, because a more favorable force distribution and simpler assembly are thus guaranteed, and the bracket body may be cast or shaped from sheet metal.

It is advantageous that the connector is designed as a clamping pin with a head designed as a spindle nut, because a simple clamping connection can thus be embodied.

The oblong passage opening may be designed as an elongated hole formed in the direction of adjustment, so that a guiding possibility that can be manufactured in a simple manner can be embodied.

Another advantage is that the clamping part is designed as a multipart clamping part with a lever, as a result of which this would be able to be used in the clamping mechanisms known from the state of the art.

Another measure improving the present invention is that the mounting part of the second clamping mechanism is designed as a yoke, so that the spindle is guided axially and radially and more reliable clamping can thus be guaranteed.

The pitch of the spindle is preferably selected to be such that self-locking is achieved because of the spindle pitch selected and a safety function is thus guaranteed.

The connecting piece is preferably designed as a jacket tube with a welded-on U-shaped carrier, which has a through hole on each leg for connection with the connector designed as a connecting pin, because a simple possibility of manufacture along with improved force distribution is thus guaranteed.

The first clamp can include a quick release lever mechanism, where movement of the quick release lever mechanism selectively tensions the clamping pin to clamp and unclamp the first clamp and also lock and unlock the second clamp. The first clamp can also include a positioning device for positioning the quick release lever mechanism. The quick release lever mechanism is arranged between the first connecting piece and the positioning device, where rotation of the quick release lever mechanism expands and contracts the quick release lever mechanism to selectively clamp and unclamp the first clamp and also lock and unlock the second clamp.

The second clamp preferably includes a spindle pin rotatably mounted in the spindle nut to adjust a position of the spindle nut in the adjusting direction. Clamping of the first clamp applies a force to the spindle pin to block the spindle pin from rotating. The second clamp then preferably includes a yoke to receive the spindle pin. The spindle pin contacts the yoke to block rotation of the spindle pin and lock the second clamp when the first clamp applies force to the spindle pin. The yoke can have a wedge shaped surface contacting the spindle to block rotation of the spindle pin when the first clamp applies force to the spindle pin. The yoke is fixed to the first connecting piece.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

FIG. 1 is an isometric schematic view of a first mounting part according to the present invention;

FIG. 2 is an isometric schematic view of a connecting piece according to the present invention, which is designed as a jacket tube of a motor vehicle steering column;

FIG. 3 is a cross section of a schematic view of a nonpositive clamping device according to the present invention without a second clamping mechanism;

FIG. 4 is a cross section of a schematic view of a combination according to the present invention of a nonpositive clamping mechanism and a positive-locking clamping mechanism;

FIG. 5 is a section along the section line A-A in FIG. 4; and

FIG. 6 is a detail view of FIG. 4.

### DESCRIPTION OF THE PREFERRED EMBODIMENT

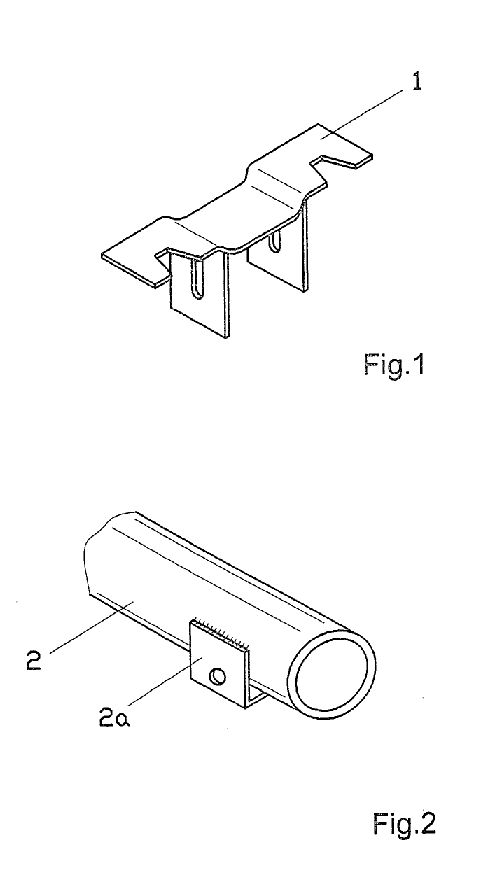

The steering column bracket body 1 according to FIG. 1 is U-shaped and has an elongated hole 1a per leg. This elongated hole is used to guide the connector of the first clamping mechanism and guarantees an adjustment possibility. The body is bent from a sheet metal here.

FIG. 2 shows a fastening device 2a, which is welded to a jacket tube 2, which accommodates the complete steering shaft with the mount and the adjoining components (not shown), and has two holes for being accommodated between the clamping parts of the first clamping mechanism.

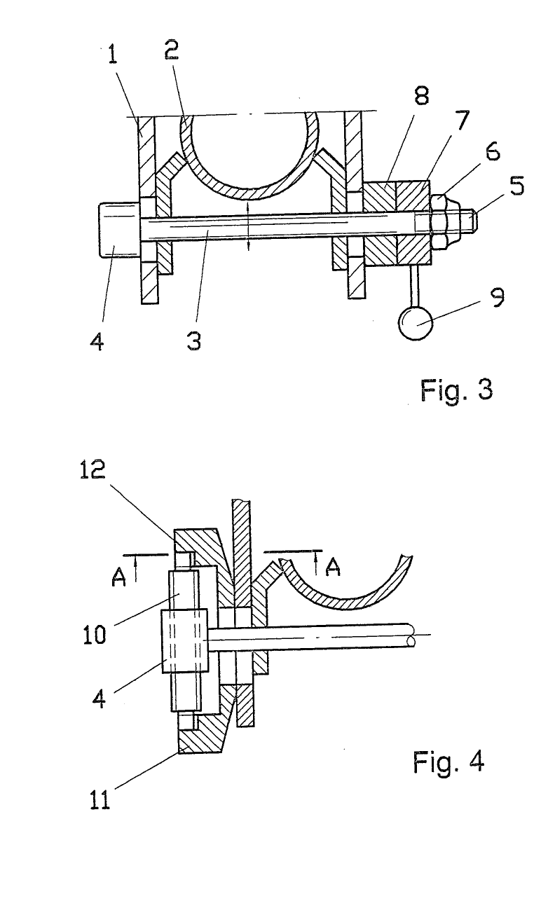

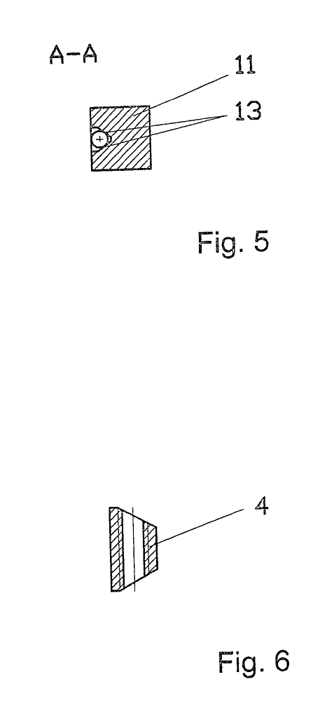

The clamping mechanism according to FIG. 3 comprises a connecting pin 3 with a head 4, which has a threaded section 5 on the side of the pin located away from the head for setting a self-securing adjusting nut 6. The clamping parts 7, 8, designed as a stepped disk, needle mechanism or thread pitch, with a lever 9, which generates a lifting movement between the clamping parts 7, 8 by pivoting around a pin axis and thus releases or locks the clamping mechanism, are located between the right-hand leg of the fastening device 2a of the jacket tube 2 and the adjusting nut 6.

FIG. 4 shows a spindle 10, in which the head 4 is designed as a spindle nut. The spindle 10 is clamped axially and radially in the yoke surface 12, 13, which can be seen more clearly in section A-A, by means of the clamping mechanism from FIG. 3. The yoke 11 prevents an axial adjustment of the spindle. The oblong opening of the yoke 11 corresponds to the passage opening 1a of the steering column bracket 1 shown in FIG. 1. When the steering column is adjusted, the clamping mechanism in FIG. 3 and consequently also the clamping mechanism in FIG. 4 are opened, and thus they make possible an axial adjustment. The clamping pin head 4 moves axially during the adjustment process, and the spindle 10 rotates during this movement. The entire adjustment process can also be thought to be such that after releasing the clamping of the clamping mechanism in FIG. 3, the spindle 10 is rotated, for example, by means of an electric motor (not shown). This rotation is transformed via the head 4 into a translation taking place in the axial direction and thus it adjusts the steering column.

While a specific embodiment of the invention has been shown and described in detail to illustrate the application of the principles of the invention, it will be understood that the invention may be embodied otherwise without departing from such principles.

### APPENDIX

List of Reference Numbers:

1 Mounting part

1a Passage opening

2 Connecting piece

2a Fastening device

3 Connector

4 Left-hand clamping part (pin head)

5 Threaded section

6 Self-securing adjusting nut

7 First clamping part

8 Second clamping part

9 Lever

10 Spindle

11 Mounting part (yoke)

12 Axial guide

13 Radial guide

What is claimed is:

1. A safety device for locking an adjustable connecting piece, the safety device comprising:
first connecting piece defining at least one said passage opening;
a second connecting piece arranged in said first connecting piece;
a connector arranged in said passage opening;
two clamping parts connected to each other through said connector, said two clamping parts are movable in relation to one another through via the connector and clamp said second connecting piece, wherein said connector and said clamping parts form a first clamping mechanism and, furthermore, means for securing the first clamping mechanism are provided, the means for securing said first clamping mechanism comprise a second clamping mechanism which is located between said clamping parts of said first clamping mechanism and is coupled with same, wherein said second clamping mechanism has a mounting part which has a passage opening that is substantially congruent with said passage opening of said first connecting piece and comprises a said spindle which is connected with said first clamping mechanism via one of said clamping parts of said first clamping mechanism, said one clamping part is designed as a spindle nut, so that both said clamping mechanisms can be released or locked via said first clamping mechanism.

2. A safety device for locking an adjustable connecting piece in accordance with claim 1, wherein: said first connecting piece is designed as a bracket shaped as a U-shaped part, whose legs have an elongated hole each, said legs accommodating said second connecting piece by a fastening device.

3. A safety device for locking an adjustable connecting piece in accordance with claim 1, wherein: said connector is a clamping pin with a head designed as said spindle nut.

4. A safety device for locking an adjustable connecting piece in accordance with claim 1, wherein; said elongated passage opening of said first connecting piece is an elongated hole formed in a direction of adjustment.

5. A safety device for locking an adjustable connecting piece in accordance with claim 1, wherein: said one clamping part is designed as a multipart clamping part with a lever.

6. A safety device for locking an adjustable connecting piece in accordance with claim 5, wherein: said multipart clamping part includes stepped disks, wherein said lever generates a stroke directed in an axial direction in relation to said connecting pieces during rotation around an axis of said connector combined with said clamping parts, which said stroke brings about the clamping.

7. A safety device for locking an adjustable connecting piece in accordance with claim 5, wherein: said multipart clamping part includes needle mechanisms, wherein said lever generates a stroke directed in the axial direction in relation to said connecting pieces during rotation around an axis of said connector combined with the clamping parts, which said stroke brings about the clamping.

8. A safety device for locking an adjustable connecting piece in accordance with claim 5, wherein: said multipart clamping part includes a thread pitch, wherein said lever generates a stroke directed in an axial direction in relation to said connecting pieces during rotation around an axis of said connector combined with said clamping parts, and said stroke brings about the clamping.

9. A safety device for locking an adjustable connecting piece in accordance with claim 1, wherein: a spindle is arranged in said spindle nut; said mounting part of said second clamping mechanism includes a yoke guiding said spindle axially and radially.

10. A safety device for locking an adjustable connecting piece in accordance with claim 9, wherein: a pitch of said spindle is selected to be such that self-locking is achieved because of the spindle pitch selected.

11. A safety device for locking an adjustable connecting piece in accordance with claim 3, wherein: said second connecting piece is a jacket tube of a steering column of a motor vehicle with a welded-on U-shaped carrier, which has a through hole on each leg for connection with said connector designed as a clamping pin.

12. A safety locking arrangement comprising:
a first connecting piece;
a second connecting piece arranged inside said first connecting piece, said second connecting piece being movably mounted in said first connecting piece in an adjusting direction;
a connector arranged around said first connecting piece, said connector having a first clamp selectively clamping said connector to said first connecting piece and fixing said first connecting piece to said second connecting piece, said connector having a second clamp selectively locking said connector to said first connecting piece and fixing said first connecting piece to said second connecting piece, said second clamp including a spindle nut, said spindle nut being connected to said first clamp to be locked and unlocked by clamping and unclamping of said first clamp.

13. An arrangement in accordance with claim 12, wherein:
said first clamp is movable outward to and inward toward the first connecting piece in a clamping direction to selectively clamp and unclamp said connector with said first connecting piece, said clamping direction being different than said adjusting direction;
said connector includes a clamping pin passing through said first connecting piece and said second connecting piece;
said clamping pin is fixed to one of said first and second connecting pieces in said adjusting direction, said clamping pin is movable in the other of said first and second connecting pieces in said adjusting direction;
said other of said connecting pieces defines an elongated hole in said adjusting direction, said clamping pin passes through said elongated hole.

14. An arrangement in accordance with claim 12, wherein:
said second clamp forms a positive locking connection between said first connecting piece and said second connecting piece, said first clamp forms a nonpositive locking connection between said first connecting piece and said second connecting piece

15. An arrangement in accordance with claim 12, wherein:
said first clamp includes a quick release lever mechanism, movement of said quick release lever mechanism selectively tensioning said clamping pin to clamp and unclamp said first clamp and also lock and unlock said second clamp.

16. An arrangement in accordance with claim 15, wherein:
said first clamp includes a positioning device for positioning said quick release lever mechanism, said quick release lever mechanism being arranged between said first connecting piece and said positioning device, rotation of said quick release lever mechanism expanding and contracting said quick release lever mechanism to selectively clamp and unclamp said first clamp and also lock and unlock said second clamp.

17. An arrangement in accordance with claim 12, wherein:
said second clamp includes a spindle pin rotatably mounted in said spindle nut to adjust a position of said spindle nut in said adjusting direction, clamping of said first clamp applies force to said spindle pin to block said spindle pin from rotating.

18. An arrangement in accordance with claim 17, wherein:
said second clamp includes a yoke to receive said spindle pin, said spindle pin contacts said yoke to block rotation of said spindle pin and lock said second clamp when said first clamp applies force to said spindle pin.

19. An arrangement in accordance with claim 18, wherein:
said yoke has a wedge shaped surface contacting said spindle to block rotation of said spindle pin when said first clamp applies force to said spindle pin.

20. An arrangement in accordance with claim 19, wherein:
said yoke is fixed to said first connecting piece;
said first and second clamps are arranged on diametrically opposite sides of said first connecting piece.
